(19) United States
(12) Patent Application Publication
(10) Pub. No.: US 2026/0073329 A1
(43) Pub. Date: Mar. 12, 2026

(54) Multi-Agent Generation And Deployment Systems And Related Methods

(71) Applicant: Oracle International Corporation, Redwood Shores, CA (US)

(72) Inventors: Amir Hossein Rezaeian, San Mateo, CA (US); Vijayalakshmi Krishnamurthy, Sunnyvale, CA (US); Aditya Banerjee, Danville, CA (US); Srinivasan Rangarajan, Pleasanton, CA (US)

(73) Assignee: Oracle International Corporation, Redwood Shores, CA (US)

(21) Appl. No.: 19/085,994

(22) Filed: Mar. 20, 2025

Related U.S. Application Data
(60) Provisional application No. 63/692,285, filed on Sep. 9, 2024.

(51) Int. Cl. G06Q 10/0631

(52) U.S. Cl. CPC G06Q 10/06316

(57) ABSTRACT

Techniques for automatically orchestrating, generating, and/or deploying a multi-agent are disclosed. A super agent ingests metadata describing a use case to identify workflows and tasks. A task assigner agent assigns the tasks to task agents. A task performer agent performs a basic task. A vertical agent performs a task using vertical resources of a system. A specialized task agent performs specialized tasks, such as those performed using a specialized language model. An orchestration agent arranges task agents into an orchestration according to a graph representation of a workflow. A compiler agent packages the orchestration into an executable. The executable is called to perform the workflow. An orchestration engine automatically selects task agents used to complete the workflow and compiles them into the executable. The system collects feedback based on the results of the executable and uses the feedback to optimize the super agent and/or the task assigner agent.

### INCORPORATION BY REFERENCE; DISCLAIMER

Each of the following applications are hereby incorporated by reference: Application No. 63/692,285 filed on Sep. 9, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to agentic systems.

### BACKGROUND

Agentic workflows are workflows that are controlled by an LLM agent. Agentic workflows that involve multiple agents performing various tasks are known as multi-agent systems or multi-agentic systems. The number of combinations of tasks is unbounded, so multi-agentic systems are applicable to uncountably many use cases for which different agent systems are optimal. Due to the expanding scope of agentic systems and their capabilities, determining components needed for an agentic system is challenging and likely to result in inefficiencies. Current agentic system generation and deployment is expensive and time-consuming, requires expertise, and is prone to human error or waste.

Techniques in this disclosure may address the aforementioned flaws, challenges, and difficulties. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example multi-agent generation system in accordance with one or more embodiments;

FIG. 2 illustrates example operations for multi-agent orchestration, generation, and deployment in accordance with one or more embodiments;

FIG. 3A-E illustrate techniques for multi-agent orchestration, generation and deployment, in accordance with one or more embodiments;

FIG. 4 illustrates an example machine learning engine in accordance with one or more embodiments;

FIG. 5 illustrates example operations for machine learning in accordance with one or more embodiments; and

FIG. 6 illustrates a block diagram of a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE MULTI-AGENT GENERATION SYSTEM
3. EXAMPLE OPERATIONS FOR MULTI-AGENT ORCHESTRATION, GENERATION, AND DEPLOYMENT
4. EXAMPLE MULTI-AGENT ORCHESTRATION, GENERATION AND DEPLOYMENT TECHNIQUES
5. MACHINE LEARNING ARCHITECTURE
6. MACHINE LEARNING OPERATIONS
7. GENERATIVE ARTIFICIAL INTELLIGENCE MODELS
8. COMPUTER NETWORKS AND CLOUD NETWORKS
9. MICROSERVICE APPLICATIONS
10. HARDWARE OVERVIEW
11. MISCELLANEOUS; EXTENSIONS

### 1. General Overview

While this General Overview section provides a general overview, additional embodiments and related combinations of features may be described in this Specification and/or recited in the claims outside of this General Overview section.

One or more embodiments provide techniques for multi-agent generation and/or deployment. Traditional agentic systems are limited to specific use cases and/or include components that are not needed for a particular use case. Components of traditional agent systems are not chosen or arranged based on a minimal set needed to perform tasks associated with a use case.

Multi-agent generation and/or deployment systems described herein generate an agentic system that includes components that are chosen based on a minimal set of needed components of the system. For example, the multi-agent generation and/or deployment orchestrates and/or compiles a callable package containing a minimal set of data plane agents.

A language model determines a set of tasks automatically based on a description of a use case. A task assigner agent automatically assigns or maps tasks to endpoints that perform the tasks (e.g., to data plane agents). For example, the task assigner agent assigns the tasks to one or more data plane agents configured chosen to be included in the minimal set. In this way, the callable package is automatically generated with an optimized configuration of data plane agents for a particular use case. Thus, a multi-agent for a particular use case is automatically generated and deployed without unnecessary data plane agents not associated with the use case. For a new use case, the agentic system is automatically deployed and a response for the new use case is generated automatically, without introducing resource waste or human error.

In some embodiments, an agent or agents in a multi-agent deployment has one or more respective prompts, LLMs, internal and/or external tool sets, memory, planning module(s), custom code, collaboration and/or interfacing code, or combinations thereof. Since a particular task agent has its own LLM, the agent can be fine-tuned for a specific task. Many data plane agents are fine-tuned for specific tasks to facilitate scalability, efficiency, and interoperability. Multi-agent deployment and generation is automated, however, feedback-based optimization, including using human feedback, is used to improve the performance of the system and/or to further optimize particular workflows or agent models. Task specific agents also often have a higher success rate than more general task agents.

### 2. Example Multi-Agent Generation System

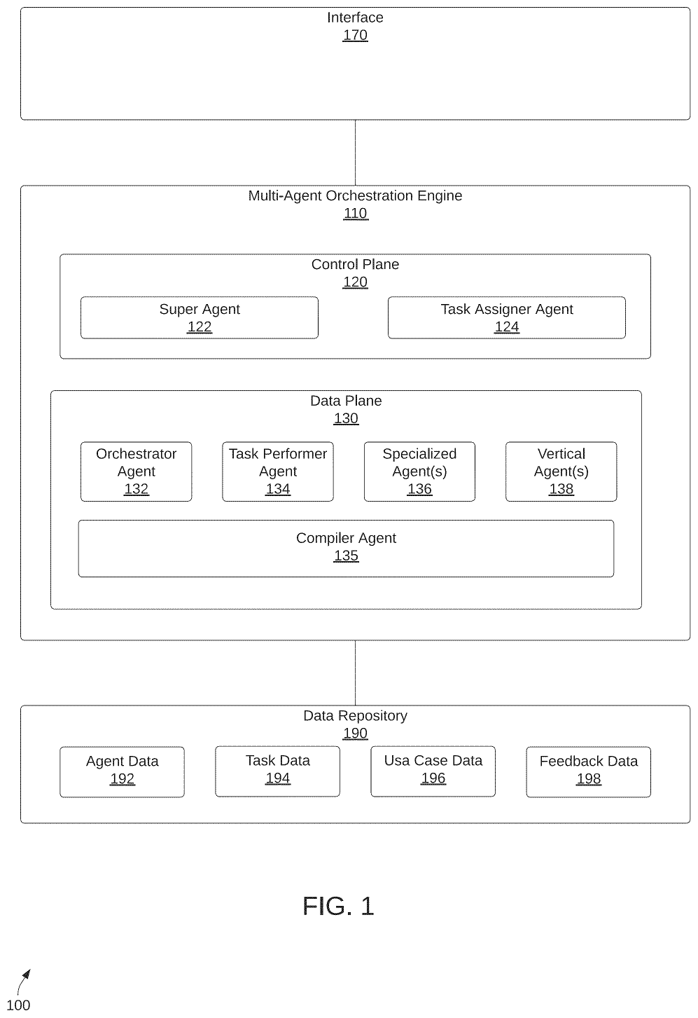

FIG. 1 illustrates an example multi-agent generation system 100 for generating and/or deploying an agentic system. In the example, the multi-agent generation system 100 includes a multi-agent orchestration engine 110, an interface 170, and a data repository 190.

In FIG. 1, the multi-agent orchestration engine 110 comprise components is a control plane 120 and components in a data plane 130. The control plane 120 comprises a super agent 122 and a task assigner agent 124. In various embodiments, the control plane 120 includes more or fewer components.

The data plane 130 comprises an orchestrator agent 132, a task performer agent 134, one or more specialized agents 136, a vertical agent 138, and a compiler agent 135. In various embodiments the data plane 130 includes more or fewer components.

In the example, the super agent 122 includes one or more language models configured for receiving input such as metadata about a use case, a user workflow trigger for a use case, and/or other data related to a use case. For example, a meta data file related to a use case includes a description of an application, an indication of one or more requirements of the application, and/or an indication of one or more resources available to the application. The super agent 122 includes one or more language models trained and/or fine-tuned to define a task, a requirement for the task, and a “backstory” (e.g. a description of available resources such as results from tasks that are available to be performed).

By way of example, the super agent 122 ingests a use case description file for a software application. A language model is configured for generating an output that identifies workflows and tasks associated with the use case. In this example, a particular workflow for a use case comprises a series of one or more tasks performed to complete the workflow. A use case includes one or more workflows. In some cases, different workflows for a use case include one or more same tasks. An example use case includes one or more digital workflows (e.g., an application, service or process) performing a plurality of methods. Metadata for the use case includes a description of the workflows, applications, services, and associated resources. The language model ingests the description of the use case to identify the methods, processes, applications, and/or services performed by the use case, the resource requirements for performing the use case, available resources for performing the use case, and/or other information about the use case.

The super agent 122 generates a description of workflows associated with use cases. For example, the super agent 122 includes a graph generator for generating a graphical description of workflows associated with the use case. The graphs include tasks of various types described by the use case arranged according to the sequences of processes (i.e., tasks) for the workflows. For example, the super agent 122 includes a graph generator model or language model that is trained and/or fine-tuned for defining workflows. In various embodiments, the graphical representations includes graphs, acyclic graphs, directed acyclic graphs (DAG)s, “red”/“black” trees, and/or other graphical data representations. The model is configured and/or fine-tuned to generate graphical representations by arranging the tasks of workflows associated with a use case in various graphical arrangements and/or by generating a text description of the arrangement of tasks. The multi-agent orchestration engine 110 generates a representation of the task types and task order for completing a workflow associated with a use case. In various embodiments, the multi-agent orchestration engine 110 accesses, generates, and/or stores a graphical representation, text description and/or vector embedding of the workflows of one or more use cases.

In some embodiments, the super agent 122 includes a language model that is trained and/or fine-tuned using definitions and/or descriptions for tasks and/or use cases. For example, the super agent 122 uses a set of task definitions to determine a set of tasks associated with a use case based on description of the use case and the set of definitions. In some embodiments, feedback for a final result is used as training data to optimize the super agent. In an embodiment, the system flags a super agent task definition based on feedback indicating some types of poor performance for a task associated with the definition. In this way, the orchestration engine 110 receives feedback based on finalized results of the orchestration engine 110 and uses the feedback optimize the model used by the super agent 122. In some embodiments, human-in-the-loop feedback is incorporated to measure and/or access direct or indirect feedback for a first task between the first task and a second task for a workflow.

The task assigner agent 124 is configured for assigning tasks that are identified by the super agent 122 to one or more agents in the data plane 130. The task assigner agent 124 includes a language model that is trained and/or fine-tuned for receiving an arrangement of tasks and generating one or more prompts for one or more assignees that are configured for performing the tasks. The task assigner agent 124 generates task definitions and instructions that are included in prompts to assignee models. In embodiments, the super agent 122 prompts and/or instructs the task-assigner agent to define different sub-tasks and/or to optimize a work flow.

For example, the super agent 122 defines a first plurality of workflows. The task assigner agent 124 assigns tasks for a second plurality of workflows that differs from the first plurality of workflows by having tasks or subtasks that are replaced with other tasks or subtasks. For example, a task appearing in the first plurality of work flows includes a first subtask and a second subtask. The task is broken into a first subtask and a second subtask in the second plurality of work flows. A particular work flow in the first plurality of workflows includes an initial task and the first task. The initial task comprises an initial subtask that provides a same result as the first subtask. The particular work flow in the second plurality of workflows includes the initial task and the second subtask. In the example, the particular work flow in the second plurality of workflows does not include the first subtask because the result is already included from the initial subtask.

In some embodiments, the task assigner agent 124 accesses a set of agent descriptions describing a plurality of data plane agents. The data plane agent descriptions include definitions of tasks for a data plane agent. The task assigner agent 124 assigns tasks according to the task types and sequence identified by the super agent 122 and the definitions of tasks for the data plane agents.

For example, the task assigner agent 124 generates an orchestration prompt describing an orchestration task and a plurality of data plane agents. The task assigner agent generates a first prompt instructing a first data plane agent to generate a first output based on the first prompt. The task assigner agent generates a second prompt instructing a second data plane agent to generate a second output based on the first output and the second prompt. The task assigner agent generates a third prompt instructing a finalizer agent to format the second output for a client device interface. The data plane agents are assigned to perform tasks, execute operations in the data plane, and output a result to a finalizer agent. In some embodiments, the results of multiple data plane agents are finalized, merged and/or ranked to produce a final result.

In certain embodiments, the task assigner agent 124 defines prompts for various types of task agents based on the type of tasks the task agents are performing. For example, the task assigner agent assigns specific tasks to task performer agents, vertical tasks to vertical task agents, specialized tasks to specialized task agents, and/or orchestration tasks to orchestration agents. The task assigner agent instructs a compiler agent to package the other data plane agents into an executable based on a structure defined by the graph representation of the agentic workflow.

In some cases, a plurality of subtasks are performed by a task agent. For example, a work flow includes data retrieval tasks and summary tasks that both include subtasks. The task assigner agent 124 assigns the data retrieval and/or summary subtasks to an SQL agent. The task assigner agent associates the SQL agent with the subtask(s) in a directed graph representation of the workflow. In this example, database querying tasks and data retrieval tasks identified by the super agent 122 in the workflow are represented in an agentic workflow graph by an SQL agent performing the tasks. In some examples, a same SQL agent performs various tasks and/or subtasks.

The orchestrator agent 132 includes a language model that receives a prompt generated by the task assignor agent. The prompt includes instructions for the orchestrator agent to manage the workflow for one or more other task agents. The orchestrator agent 132 routes tasks to or from one or more specialized agents, vertical agents, or task performer agents. The orchestrator agent 132 generates one or more router agents based on the instructions and/or prompt from the task assigner agent 124. For example, the orchestrator agent 132 generates a router agent based on an instruction included in a prompt from the task assigner agent 124 that instructs the orchestrator agent to prompt a task performer agent 134, specialized agent 136, and/or vertical agent to respond with a task result, task status, and/or agent status.

The task performer agent 134 refers to a task agent that is configured for performing a particular task, such as a calculation, a web search, and/or an input/output request. In embodiments, the task performer agent accesses or includes various task tools used for completing one or more particular tasks. For example, a tool includes methods or objects for performing one or more subtasks, and the task performer agent uses the tool to compete the subtasks for a task.

In the example, the specialized agents(s) 136 refer to agents that are specialized for a task or group of tasks by being trained and/or fine-tuned to perform the task(s) based on a prompt or other input. Example types of specialized agents 136 include an SQL agent, a RAG agent, a general AI service, an AI planner, and/or another agent including an LLM that is trained or fine-tuned for a specialized task. In some cases, the compiler agent 135 wraps or is configured for wrapping one or more specialized agents 136 so that the specialized agent(s) 136 is in a same callable package in an orchestration with, for example, the orchestration agent 132, the task performer agent(s) 134, and/or a vertical agent 138.

In FIG. 1, the vertical agent 138 includes agents interface vertically with a system. Vertical agents 138 generally do not require LLMs that are specialized for a task. Rather, the vertical agents have access to vertical system information and/or vertical resources. The vertical agents include modules for accessing vertical resources. Example specialized agents include accounting agents, procurement agents, interfacing agents, internal systems agents, and/or the like. In various embodiments, vertical agents integrate vertically with a system for a particular use case.

The compiler agent 135 includes modules for packaging one or more orchestrations in in a workflow. For example, a plurality of tasks are arranged in an orchestration between tasks agents that is handled by operators of the orchestration agent 132. In embodiments, the compiler agent 135 includes a graph builder model and/or graph builder agent arranging orchestrated tasks and/or other tasks in a workflow into a graph representation. The compiler agent 135 packages the orchestrator agent 132, the task performer agent(s) 134, the specialized agent(s) 136, and the vertical agent 138 into a callable package matching the mapping of the graph representation. For example, an orchestrator agent 132, one or more task performer agent(s) 134, a specialized agent 136, and a vertical agent 138 are compiled into a triggerable workflow. The callable workflow is executed automatically responsive to a trigger or condition via an application programing interface. In embodiments, the compiler agent 135 packages different orchestrations for diverse specialized and/or vertical components. In various embodiments, one or more outputs of the multi-agent orchestration engine 110 are ranked, reranked, merged, formatted and/or otherwise finalized.

The interface 180 facilitates communicating with external computing devices and/or with input/output operations. The interface 180 refers to hardware and/or software configured to facilitate communication between a user device and a system. In some embodiments, the multi-agent orchestration engine 110 inputs the results of the various data plane agents to a finalizer agent which aggregates, normalizes, and/or formats the results (e.g., based on requirements described by the metadata or defined by the super agent 122) and/or sends a finalized response to another agent and/or client device.

In FIG. 1, an interface 180 is used to facilitate communication between the multi-agent orchestration engine 110 and other components of the multi-agent generation system 100 and/or external components (e.g., one or more user computing devices, client computing devices, and/or administrative computing devices). Such an interface 180 renders user interface elements and receives input via user interface elements.

Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In various embodiments, different components of such an interface are specified in different languages. The behavior of user interface elements is specified in a dynamic programming language such as JavaScript. The content of user interface elements is specified in a markup language, such as hypertext markup language (“HTML”) or extensible markup language (“XML”) User Interface Language (“XUL”). The layout of user interface elements is specified in a style sheet language such as Cascading Style Sheets (“CSS”). Alternatively, interfaces may be specified in one or more other languages, such as Java, C, or C++.

In the example, the data repository 190 includes agent data 192, task data 194, use case data 196, and feedback data 198. Agent data 192 refers to data and/or metadata identifying different agents, model, services, process, and/or other resources hosted at endpoints. Task data 194 refers to data and/or metadata describing use cases associated with various tasks and/or an agent, model, service, process, and/or other resource associated with performing a task. Task data 194 includes associations of tasks with task agents assigned to perform the tasks by the task assignor agent 124. Use case data 196 refers to data and/or metadata associated with different use cases, such as descriptions of problem statements, intentions, requirements, instructions, specifications, resources, problem statements, and/or the like. Use case data 196 includes graphical representations of workflows defined by the super agent 122.

Feedback data 198 refers to positive, negative, direct, indirect, human or other feedback received based on one or more results produced by the orchestration engine 110. For example, a rating (e.g., accuracy score) for one or more final results produced by executing a callable package generated by the multi-agent orchestration engine 110.

In embodiments, a data repository 190 stores data accessed or generated by the multi-agent generation system 100. Generally, the data repository 190 stores data loaded onto the multi-agent generation and/or another component of the multi-agent generation system 100. The data repository 190 optionally stores data loaded from other sources. In various embodiments, data is separately stored for and/or organized by various data types in the data repository 190 and/or one or more other data storage devices.

In an embodiment, the multi-agent generation system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Example Operations for Multi-Agent Orchestration, Generation and Deployment

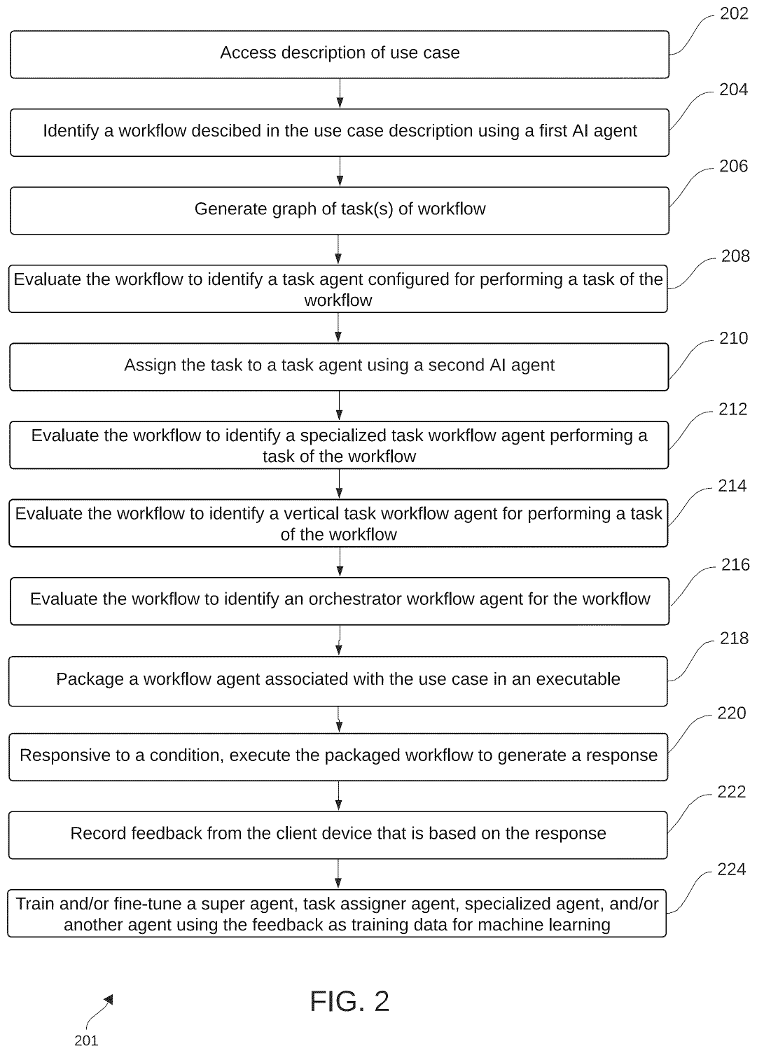

FIG. 2 illustrates example operations 201 for generating, orchestrating, and/or deploying a multi-agent. For example, operations 201 are performable by the multi-agent orchestration engine 110 and/or components of the multi-agent generation system 100 of FIG. 1.

In FIG. 2, the multi-agent orchestration engine accesses a description of a use case (Operation 202). In general, descriptions of use cases include tasks performed during various workflows of the use case and resources, requirements, results, etc., for the tasks and/or workflows. For example, metadata related to a system includes structured, partially structured, and/or unstructured text associated with use case. The metadata for the system includes a description of one or more use cases of the system. Different use cases have different sets of associated workflows. Likewise, different workflows have different sets of associated tasks. Descriptions of the use cases include descriptions of tasks that include resources, requirements, contextual information, etc., for the tasks. In some cases, the engine accesses domain-specific knowledge for a use case that supplements the description of the tasks in the use case meta data.

The multi-agent orchestration engine identifies a workflow described in the use case description using a first artificial intelligence (AI) agent (Operation 204). The engine identifies tasks associated with the use case based on the text and one or more task definitions. Descriptions of tasks include resources, requirements, contextual information, etc. In some embodiments, domain knowledge is used to train an LLM to identify task requirements, task results, contextual information about the tasks, and the like, for a particular use case. The domain knowledge is used to define tasks and/or subtasks from the use case metadata.

An example first AI agent is referred to as a “super agent.” The super agent includes a language model (or LLM) that is trained and/or fine-tuned for generating workflows of tasks from a metadata description of a use case input into the super agent. The super agent uses domain knowledge to define tasks and from the use case information in the meta data description. In embodiments, the super agent identifies one or more task agents suitable for performing tasks or subtasks of a workflow. The super agent identifies the one or more task agents based on the metadata description of the use case and/or domain knowledge. For example, an LLM identifies several tasks of a workflow based on metadata. The LLM determines that a first task is a vertical task and is suitable for being performed by a vertical task agent. The LLM determines that a second task is a specialized task and is suitable for being performed by a specialized task agent. The LLM determines that a third task is not a vertical or specialized task and is suitable for being performed by a unitary task agent. The LLM determines a fourth task is an orchestration task. In this way, the LLM determines the tasks and types of task agents suitable for performing the tasks.

The first AI agent generates a graph of one or more tasks of a workflow of the use case description (Operation 206). In this example, the first AI agent processes input metadata, such as a description of a use case and/or workflow, to identify a set of one or more tasks or subtasks for performing the workflow or achieving a desired result of the use case. In embodiments, a super agent identifies and/or graphs sequences of tasks for workflows of a use case. In some cases, the super agent determines a minimal set of workflows for achieving results of a use case. For example, the minimal set of workflows does not include redundant or inefficient workflows that are identified by the super agent.

The multi-agent orchestration engine evaluates the workflow to identify a task agent configured for performing a task of the workflow (Operation 208). For example, a second AI agent includes a second language model (or LLM) and acts as a task assigner agent. The task assigner agent identifies one or more data plane agents, such as one or more task agents, specialized task agents, vertical task agents, orchestration task agents, and/or compiler agents, suitable for completing the workflow. In an embodiment, the task assigner agent uses domain knowledge about the data plane agents (e.g., ingests metadata descriptions about the data plane agents) to identify a data plane task agent best suited for performing a particular task.

A second AI agent assigns the task to a task agent (Operation 210). The second AI agent assigns the task to the task agent by mapping the agent to a node of a graph representation of the workflow. The graph representation is used by a compiler agent to generate an executable package that calls the task agent to perform the task. In embodiments, the second AI agent includes a language model (or LLM) that generates a prompt that is input into the task agent. The task assigner agent generates the prompt based on the metadata description of the use case, domain knowledge about the task, and/or domain knowledge about the data plane task agent.

In various embodiments, the task assigner agent generates task-specific prompts based on the type of a task and the properties of the agentic task graph representation. If the type of a task is not a vertical or specialized task, the prompt includes instructions to complete the task. For example, the task assigner agent assigns a data plane task to a task performer agent and generates a prompt or other trigger that causes the task performer agent to perform the task. In various embodiments, the prompt includes instructions such as a response format, a condition related to a state of the workflow, or a requirement, restriction, or prohibition for a response. For example, a task performer agent is tasked with performing a calculation and is instructed to respond with a certain unit and number of significant figures.

If the task is a vertical task, the task assignor agent creates a prompt for a vertical task agent that includes a description of vertical resources available to the vertical agent. The prompt includes a description of capabilities of the vertical agent and/or instructions for how to respond. The prompt includes a description of steps to take to complete the task. For example, the prompt includes instructions for a vertical task agent to receive a first result from a first vertical resource. The prompt includes instructions for the vertical task agent to receive a second result from a second vertical resource. In some embodiments, the second result from the second vertical resource is dependent on the first result of the first vertical resource. For example a first resource is a security token that is needed to access a second resource.

If the task is a specialized task, the prompt includes a description of a tool and a resource. The prompt includes a description of the resource. Example resources include a knowledge base or a relational database. The prompt includes instructions for a specialized agent to generate an auxiliary query and to generate a result the tool based on the auxiliary query. For example, the prompt generated by the task assigner for a specialized task that is an SQL task includes instructions to an SQL agent to generate an SQL query and to respond with results of executing the SQL query. The prompt also includes information about the resource (i.e., the relational database), such as table names, column names, datatypes, etc.

If the task is an orchestration task, the task assigner prompt includes a description of one or more task agents (“worker agents”). The task assigner prompt includes an one or more auxiliary prompts that the orchestrator agent is instructed to provide to one or more worker agents. In embodiments, the task assigner prompt includes instructions to respond with one of the worker agents based on a state of executing the workflow. The instructions include an instruction to select one or more worker agents and/or to receive one or more results from one or more worker agents. In some embodiments, the prompt includes instructions to reply with the results from the worker agents and an indication that the orchestration task is finished (e.g., completed).

The task assigner agent assigns tasks to data plane agents based on the type of the task identified by the super agent. Continuing the example above, the second LLM assigns the first task (a vertical task) to a vertical task agent. The second LLM assigns the second task (a specialized task) to a specialized task agent. The second LLM assigns the third task to a data plane task agent. The LLM assigns the fourth task (an orchestration task) to an orchestration agent.

The multi-agent orchestration engine evaluates the workflow to identify a specialized task workflow agent performing a task of the workflow (Operation 212). In this operation, the engine identifies a task agent that uses a specialized model. For example, a RAG agent includes a specially trained retrieval model. In another example, an SQL agent includes a specially trained language model.

The multi-agent orchestration engine evaluates the workflow to identify a vertical task workflow agent for performing a task of the workflow (Operation 214). In various embodiments, a vertical task agent performs a task that interacts vertically with a system. For example, vertical-specific agents include accounting agents or procurement agents. Such agents access components of related systems to perform vertical tasks. These agents receive results from the vertical components of the system. The engine evaluates the workflow to determine one or more tasks that require vertical integration with a system.

The multi-agent orchestration engine evaluates the workflow to identify an orchestrator workflow agent for the workflow (Operation 216). For example, multi-agent orchestration engine identifies a relationship between a first task formed by a first task agent and a second task performed by a second task agent. The engine identifies an orchestrator agent for the first task and the second task. The orchestrator agent receives an orchestration prompt from the task assigner agent that includes an identification of the first task agent, an identification of the second task agent, a description of the relationship between the first task agent and the second task agent (i.e., a description of their hierarchical relationship in a graph representation). The interactions between task agents and the state management between the task agents are defined by the orchestrator agent according to instructions in the prompt provided to the orchestrator agent from the task assigner agent. The orchestrator agent generates prompts for the task agents based on the auxiliary prompt from the task assignor agent.

The orchestrator agent generates one or more routers to handle interactions between task agents and to maintain state definitions as control is passed between agents. The orchestrator agent controls interactions between other data plane agents via the routers. The routers facilitate communication (e.g., by interfacing inputs and outputs) between the one or more task agents, vertical agents, and/or specialized agents. In some cases, the orchestrator agent generates one or more router agents that receive diverse outputs from task agents. If the outputs are diverse, the router agents reformat the diverse outputs to a common format. In some embodiments, a workflow includes a plurality of orchestrator agents. In embodiments the orchestrator agent transforms the output of one or more agents into a standardized format. In this way, specialized agents or vertical agents that are diverse in nature are wrapped by a common interface and inserted into a workflow without disruption.

The multi-agent orchestration engine packages a workflow agent associated with the use case in an executable (Operation 218). For example, the multi-agent orchestration engine packages a plurality of workflow agents according to a hierarchy defined by an agentic task graph representation of the workflow. In embodiments, the engine also packages one or more other workflow agents according to a hierarchy defined by one or more agentic task graph representations of workflows of a use case. In embodiments, the engine generates an executable package for one work flow. In other embodiments, the engine generates an executable package for a plurality of workflows for a use case.

In an example embodiments, the executable includes one or more task agents, vertical agents, specialized agents, and/or orchestration agents. The multi-agent orchestration engine defines the task agents as self-contained modules within a graph representation. The task agents are implemented as nodes, and the connections between the agents are defined as edges that represent communication and control flow during the workflow. The compiler agent analyzes the hierarchy of tasks in the graph structure, resolves dependencies, and rewrites the agent assignments and prompts generated by the task assigner agent into low-level, executable code that mirrors the agentic task graph representation. The compiler agent converts the agentic workflow to a format that is executable and/or accessible via an API.

In embodiments, the compiler agent and/or the orchestration agent adhere to a common interface for communication. The orchestration agent packages task agents into wrapped packages that adhere to the common interface. The compiler agent packages the wrapped packages into an executable that adheres to an interface suitable for enabling the executable to be accessed by a client device. In various embodiments, the compiler agent performs tasks such as static analysis, optimization, code generation, and code linking to package the agents into a unified executable. Graph representations offer a versatile representation of any workflow. By leveraging a compiler agent the graph representations are transformed into fully functional, executable packages. This process automates compilation and increases consistency, efficiency, and scalability across various workflows.

Responsive to a condition, the multi-agent orchestration, generation, and deployment system executes the packaged workflow to generate a response (Operation 220). For example, a user sends a request to execute the packaged workflow via a client device to a server hosting the workflow at a networked location accessible via an API. In another embodiment, a multi-agent service interacts with a client device. Responsive to the client device requesting a workflow of a use case, the multi-agent service calls the executable package. In other various embodiments, the executable package is executed responsive to various triggers, conditions, or criteria.

The multi-agent orchestration, generation, and deployment system records feedback from the client device that is based on the response (Operation 222). In various embodiments, the executable package generated by the multi-agent orchestration, generation, and deployment system is executed on one or more client devices. Users of the client device provide feedback of various types of feedback (positive, negative, direct, indirect, scoring, etc.) indicating whether the result of the executable package successfully completed the intended workflow. This feedback can come in various forms, such as explicit human evaluations, corrections, and ratings, or implicit signals gathered from user interactions and performance metrics.

The multi-agent orchestration, generation, and deployment system trains and/or fine-tunes a super agent, task assigner agent, specialized agent, and/or another agent using the feedback as training data for machine learning (Operation 224). In various examples, the multi-agent orchestration, generation, and deployment system fine-tunes the super agent for identifying tasks and/or fine-tunes the task assigner agent for assigning tasks. LLMs are generally initially trained on large datasets and/or domain specific knowledge. Pretrained models are then fine-tuned with targeted feedback that is specific to a specialized task. However, feedback is also suitable for initial training of an LLM.

By incorporating feedback, the multi-agent orchestration, generation, and deployment system adjusts parameters of the LLMs deployed by the super agent and/or the task assigner agent adjusts to reduce errors, improve accuracy, and better align outputs with the desired outcomes. Various iterative feedback-loop processes and optimization techniques enable the model to continually refine its understanding and performance at specialized tasks. In embodiments, feedback includes an indication of whether a correct task was selected and/or performed. This feedback is used by the super agent to optimize identification of tasks from metadata. In another embodiment, feedback includes an indication of whether an attempt to perform a correct task was successful. This feedback is used by the task assigner agent to optimize assignment of tasks to data plane task agents.

### 4. Example Multi-Agent Orchestration, Generation, and Deployment Techniques

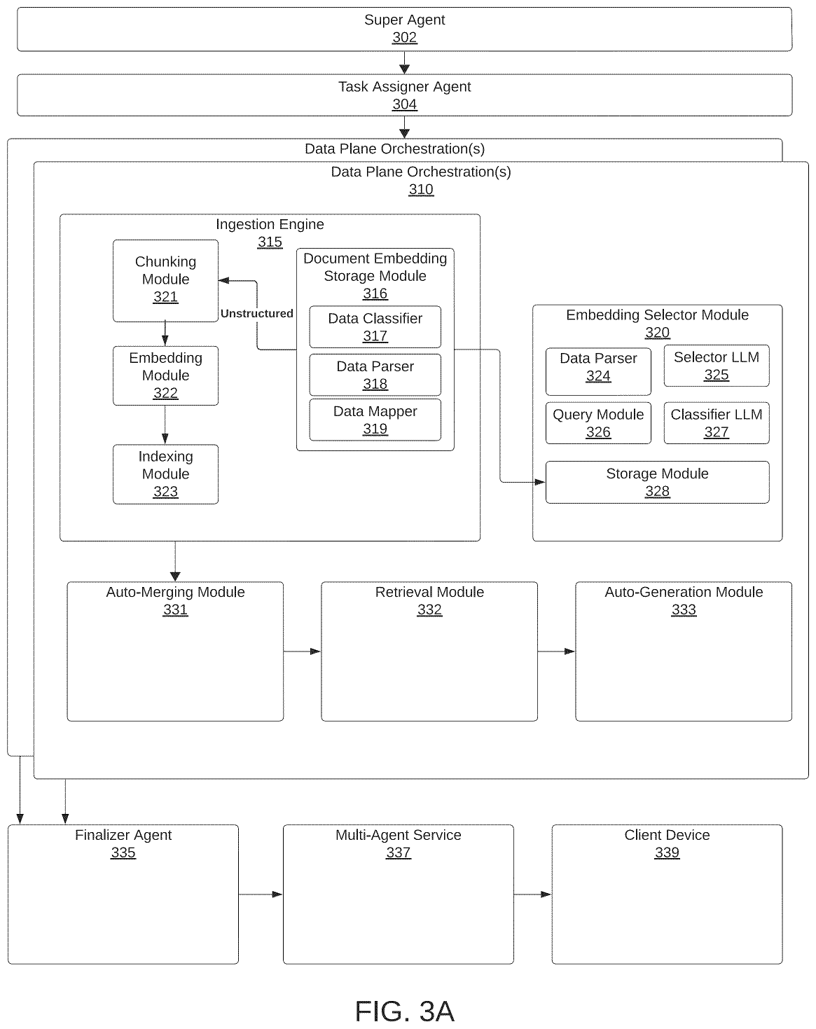

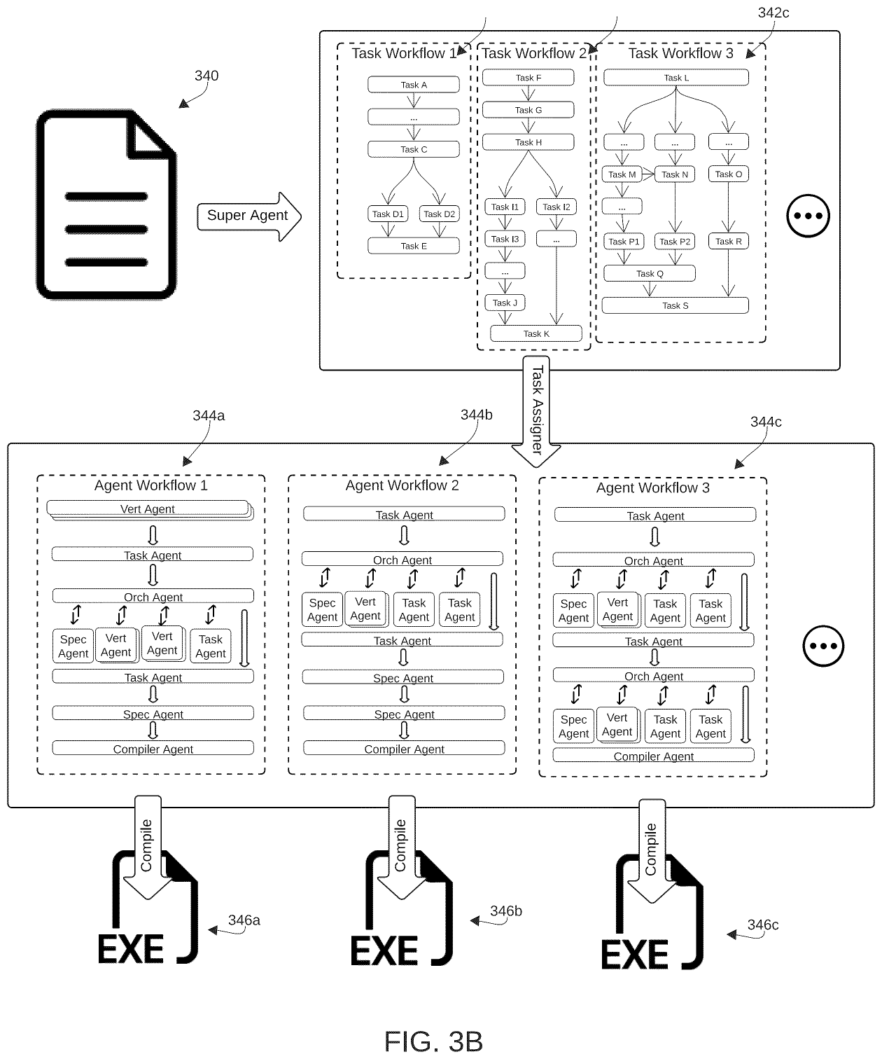

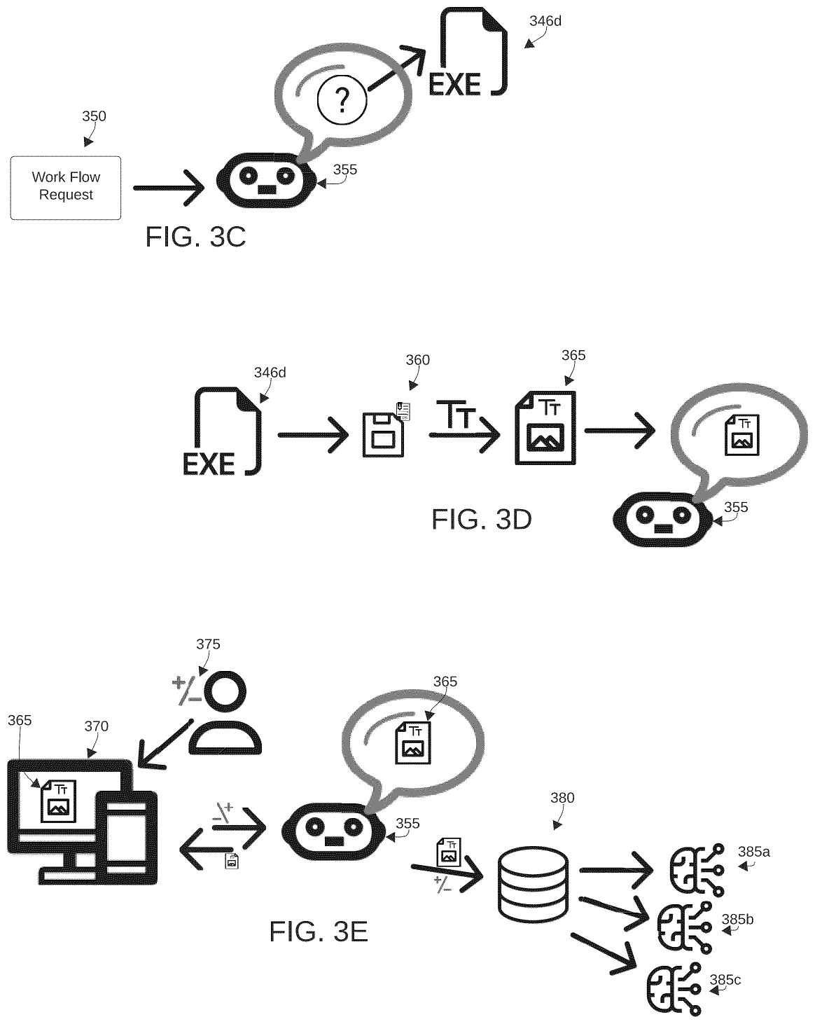

FIG. 3A illustrates an example of multi-agent deployment. In FIG. 3A, a super agent 302 including an LLM provides task workflow graphs to a task assigner agent 304 that also includes an LLM. The task assigner agent assigns one or more tasks or subtasks to one or more agents and generates an agentic task workflow graph.

In FIG. 3A, the task assigner agent 304 assigns tasks to data plane agents in a data plane orchestration 310. In various embodiments, one data plane orchestration performs one or several workflows. The system executed multiple instances of the data plane orchestration 310 to perform a workflow of the use case multiple times.

In the example of FIG. 3A, the data plane orchestration 310 include an ingestion engine 315, an embedding selector module 320, an auto-merging module 331, a retrieval module 332, and an auto-generation module 333. In the example, the data plane orchestration 310 outputs one or more results to a finalizer agent 335.

As shown in FIG. 3A, the ingestion engine 315 includes a document embedding storage module 316 comprising a data classifier 317, a data parser 318, and a data mapper 319. The ingestion engine 315 also includes a chunking module 321, an embedding module 322, and an indexing module 323. The document embedding storage module 316 classifies, parses, and/or maps structured data contained in a document.

The embedding selector module 320 includes a data parser 324, a selector LLM 325, a query module 326, a classifier LLM 327, and a storage module 328. Structured data that is classified, parsed, and/or mapped by the document embedding storage module 316 is stored in the storage module 328.

The document embedding storage module provides unstructured data to the chunking module 321 which chunks the unstructured data. The chunks of unstructured data are provided to the embedding module 322 which generates embeddings from the chunks. The indexing module 323 indexes the embeddings and stores them in data storage. The various agents, models, and modules are identified by the super agent 302. The task assignor agent 304 generates prompts for the various agents of the data plane orchestration 310.

As illustrated in FIG. 3A, the auto-merging module 331 transforms and/or automatically merges content from various embeddings or other sources. The retrieval module 332 includes components for retrieving results, post-processing of the results and ranking or reranking of the results. The auto-generation module 333 includes components for accessing a system prompt or a generation prompt. The prompt is provided to an LLM to result in a response being received by the auto-generation module.

In various embodiments, the finalizer agent 335 receives the different outputs of the data plane orchestration modules and generates a finalized response based on the different outputs. The finalized response is provided to the multi-agent service 337.

The multi-agent service 337 is accessed by a client device 339. The multi-agent service 337 interfaces with the client device 339 and provides the finalized response to the client device in response to a request or trigger for initiating the workflow in the data plane orchestration 310.

FIG. 3B illustrates the generation of a callable multi-agent package by a multi-agent orchestration engine. In FIG. 3B, a document 340 includes metadata describing a use case. A super agent includes an LLM that is trained and/or fine-tuned to generate task workflows based on the input metadata.

In the example of FIG. 3B, the super agent defines a plurality of task workflows described by the metadata including a first task workflow 342a, a second task workflow 342b, and a third task workflow 342c. Although three task workflows are illustrated, a use case may have any number of task workflows associated therewith. Some task workflows are simple, whereas others are more complex. There is not a limit to the complexity or number of tasks. The workflows shown are for illustrative purposes and are not limiting in nature.

As shown in FIG. 3B, a task assigner agent maps the tasks from the task workflows to one or more data plane agents configured for performing the tasks. In various embodiments, a task, subtask, or set of tasks of the task workflow graphs is mapped to an agent that performs the task, subtask, or set of tasks. Although three agentic workflows are illustrated, a use case may have any number of agentic workflows associated therewith. Some agentic workflows are simple, whereas others are more complex. There is not a limit to the number or complexity of structure of data plane agents needed for performing the tasks. The workflows shown are for illustrative purposes and are not limiting in nature.

In general, several challenges are accounted for in the graphs illustrated in FIG. 3B. Building a multi-agent system using a graph-based involves using nodes and edges to represent components of workflows. In a task workflow graph, nodes represent a task that is a distinct function or computational step such as processing input, and making a decision, or interacting with an external API.

Routers that are generated by the orchestration agent maintain the state of the workflow. In some embodiments, a workflow state is a dynamic state that is passed from one node to the next, so that workflows where computational steps are interdependent are completed. Edges connect these nodes and define the flow of computation. The task assigner provides an auxiliary prompt to the orchestrator agent that specifies how state propagation throughout the graph is accounted for. For example, proper completion of a workflow sometimes requires security keys to be returned. Failure of state management sometimes results in failure to account for whether a key is received before proceeding to a next node, resulting in a failed workflow. Managing the state effectively is crucial, as various nodes receive, potentially modify, and propagate a current state forward.

The interactions and orchestration among agents are clearly defined by the task assigner agent. Sometimes the definitions are based on specific domain knowledge. Such domain knowledge is input into engine by providing the domain knowledge to the super agent and/or task assigner agent to facilitate identifying tasks and optimal task assignment. For example, domain knowledge includes metadata document description language that indicates or maps to a particular workflow task. Also, domain knowledge includes a mapping of workflow tasks to workflow agents suitable for performing the tasks. Examples of domain knowledge include definitions of tasks based on metadata descriptions or information about what tasks a data plane agent is capable of completing, or other information about a data plane agent such as an accuracy or efficacy score of a data plane agent for a particular task.

In an agentic workflow graph, a node represents a task or set of tasks that is performed by a data plane agent of the multi-agent system. For example, the task assigner agent identifies tasks, subtasks, or sets of tasks in task workflow graphs that are handled by a data plane agent. Such a data plane agent performing a task or set of tasks is depicted as a node, with the interactions and connections between data plane agents illustrated as edges. The control flow of the agentic system is defined by these nodes and edges. Dead-end node (e.g., nodes without outgoing edges) sometimes lead to errors if not properly managed. Such nodes are defined in the graph representations with edges leading to an end node. Results are provided to a finalizer agent, ranking/reranking agent, and/or a merging agent to produce a final result.

Notably, frameworks such as LangGraph support conditional edges, which enable the system to dynamically determine the subsequent node to execute based on the current state, thus adding flexibility to the workflow and enabling task workflows to be mapped to agentic workflows. This approach is exemplified in both collaborative and supervisory multi-agent system configurations by the LangGraph framework. LangGraph extends a library that allows coordination of multiple chains across multiple steps of computation, in a cyclic or non-cyclic manner. In this context, LangGraph is a tool for building stateful, multi-agent applications based on a graph representation of an agentic workflow.

As illustrated in FIG. 3B, the task assigner agent assigns task agents for a first agentic workflow 344a, a second agentic workflow 344b, and a third agentic workflow 344c. In the example, the first agentic workflow 344a is packaged in a first executable 346a, the second agentic workflow 344b is packaged in a second executable 346b, and the third agentic workflow 344c is packaged in a third executable 346c. In other embodiments, a plurality of agentic workflows are packaged in an executable.

FIG. 3C illustrates by a multi-agent service identifying a callable package based on a user work flow request. In FIG. 3C, a work flow request 350 is received by a multi-agent service 355. The work flow request includes a request for a particular task of task workflow of a use case. The multi-agent service identifies an executable 346d for an agentic workflow that corresponds to the workflow request. The executable 346d was previously generated to perform an agentic workflow that completes the task workflow associated with the request. The executable 346d is packaged with an application programming interface that enables the multi-agent service 355 to call and/or execute the executable 346d. The multi-agent service 355 calls the executable 346d using the application programming interface.

FIG. 3D illustrates a response by a multi-agent service using a callable multi-agent package. In FIG. 3D, the executable 346d is called and/or executed to result in a first result 360. In the example, the first result 360 is processed to obtain a final result 365 that is presented to the user via the multi-agent service 355. In various embodiments, the first result 360 is ranked, reranked, formatted, merged with other results and/or otherwise finalized to result in the final result 365.

FIG. 3E illustrates feedback-based optimization and/or fine-tuning of one or more language models using feedback that is based on the final result 365. In FIG. 3e, the final result 365 is displayed on a user device 370, such as a computer or smart phone. A user provides feedback 375 for the final result 365. In various embodiments, the feedback is positive or negative. In other embodiments, the feedback is a rating or score. In various embodiments, the feedback 375 is direct feedback (e.g., is directly input by a user) or indirect feedback (e.g., is inferred by a user action).

As shown, the multi-agent service 355 collects the feedback 375 and/or stores the feedback 375 in a data repository 380. In various embodiments, the feedback 375 is used to train and/or fine-tune a first LLM 385a that is utilized by a super agent, a second LLM 385b that is utilized by a task assigner agent, and/or one or more other LLMs 385c that are utilized by a data plane agent (e.g., a task agent, specialized agent, vertical agent, or orchestrator agent). Additional feedback is subsequently collected for the system using one or more fine-tuned LLMs, facilitating a feedback loop that continuously improves the system.

### 5. Machine Learning Architecture

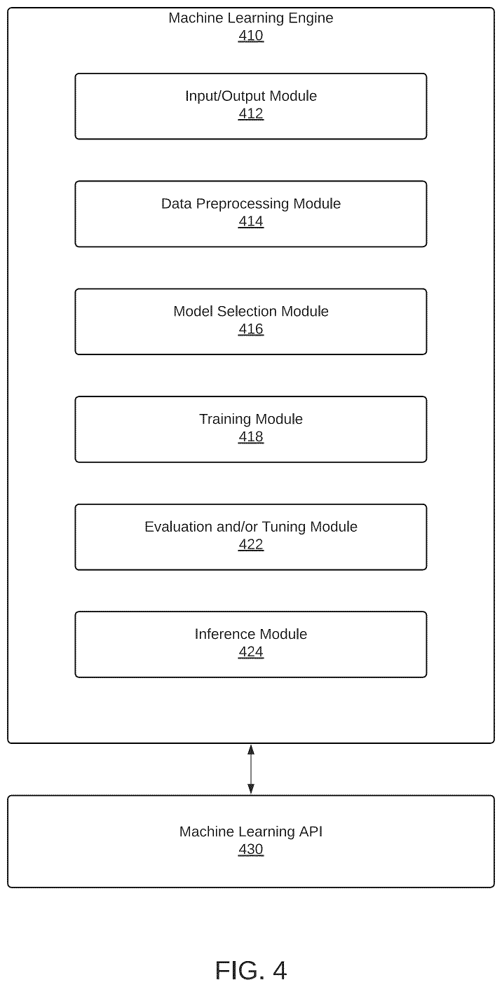

FIG. 4 illustrates a machine learning engine 410 in accordance with one or more embodiments. As illustrated in FIG. 4, machine learning engine 410 includes input/output module 412, data preprocessing module 414, model selection module 416, training module 418, evaluation and tuning module 422, and inference module 424.

In accordance with an embodiment, input/output module 412 serves as the primary interface for data entering and exiting the system, managing the flow and integrity of data. This module may accommodate a wide range of data sources and formats to facilitate integration and communication within the machine learning architecture.

In an embodiment, an input handler within input/output module 412 includes a data ingestion framework capable of interfacing with various data sources, such as databases, Application Programming Interfaces (API)s, file systems, and real-time data streams. This framework is equipped with functionalities to handle different data formats (e.g., CSV, JSON, XML) and efficiently manage large volumes of data. It includes mechanisms for batch and real-time data processing that enable the input/output module 412 to be versatile in different operational contexts whether processing historical datasets or streaming data.

In accordance with an embodiment, input/output module 412 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 412 includes an output framework designed to handle the distribution and exportation of outputs, predictions, or insights. Using the output framework, input/output module 412 formats these outputs into user-friendly and accessible formats, such as reports, visualizations, or data files compatible with other systems. Input/output module 412 also ensures secure and efficient transmission of these outputs to end-users or other systems in an embodiment and may employ encryption and secure data transfer protocols to maintain data confidentiality.

In accordance with an embodiment, data preprocessing module 414 transforms data into a format suitable for use by other modules in machine learning engine 410. For example, data preprocessing module 414 may transform raw data into a normalized or standardized format suitable for training ML models and for processing new data inputs for inference. In an embodiment, data preprocessing module 414 acts as a bridge between the raw data sources and the analytical capabilities of machine learning engine 410.

In an embodiment, data preprocessing module 414 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 414 may be configured to handle anomalies in different ways depending on context. Data preprocessing module 414 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 414 includes a feature encoding framework that ensures categorical variables are transformed into a format that can be easily interpreted by machine learning algorithms. Techniques, such as one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 414 processes new data for inference, data preprocessing module 414 replicates the same preprocessing steps to ensure consistency with the training data format. This helps to avoid discrepancies between the training data format and the inference data format, thereby reducing the likelihood of inaccurate or invalid model predictions.

In an embodiment, model selection module 416 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 416 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 416 utilizes techniques from the field of Automated Machine Learning (AutoML). AutoML systems automate the process of model selection by rapidly prototyping and evaluating multiple models. They use various techniques, like Bayesian optimization, genetic algorithms, or reinforcement learning, to explore the model space efficiently. Model selection module 416 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. Mean squared error measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 416 also considers computational efficiency and resource constraints. This is meant to help ensure the selected model is both accurate and practical in terms of computational and time requirements. In an embodiment, certain features of model selection module 416 are configurable such as a configured bias toward (or against) computational efficiency.

In accordance with an embodiment, training module 418 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 418 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 418 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 418 includes logic to handle different types of data and learning tasks. For instance, it includes different training routines for supervised learning (where the training data comes with labels) and unsupervised learning (without labeled data). In the case of deep learning models, training module 418 also manages the complexities of training neural networks that include initializing network weights, choosing activation functions, and setting up neural network layers.

In an embodiment, evaluation and/or tuning module 422 incorporates dynamic feedback mechanisms and facilitates continuous model evolution to help ensure the system's relevance and accuracy as the data landscape changes. Evaluation and tuning module 422 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 422 performs continuous model tuning by using hyperparameter optimization. Evaluation and tuning module 422 performs an exploration of the hyperparameter space using algorithms, such as grid search, random search, or more sophisticated methods like Bayesian optimization. Evaluation and tuning module 422 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 422 integrates data feedback and updates the model. Evaluation and tuning module 422 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 422 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 422 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 424 transforms raw data into actionable, precise, and contextually relevant predictions. In addition to processing and applying a trained model to new data, inference module 424 may also include post-processing logic that refines the raw outputs of the model into meaningful insights.

In an embodiment, inference module 424 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 424 transforms the outputs of a trained model into definitive classifications. Inference module 424 employs the underlying model as a tool to generate probabilistic outputs for each potential class. It then engages in an interpretative process to convert these probabilities into concrete class labels.

In an embodiment, when inference module 424 receives the probabilistic outputs from the model, it analyzes these probabilities to determine how they are distributed across some or every potential class. If the highest probability is not significantly greater than the others, inference module 424 may determine that there is ambiguity or interpret this as a lack of confidence displayed by the model.

In an embodiment, inference module 424 uses thresholding techniques for applications where making a definitive decision based on the highest probability might not suffice due to the critical nature of the decision. In such cases, inference module 424 assesses if the highest probability surpasses a certain confidence threshold that is predetermined based on the specific requirements of the application. If the probabilities do not meet this threshold, inference module 424 may flag the result as uncertain or defer the decision to a human expert. Inference module 424 dynamically adjusts the decision thresholds based on the sensitivity and specificity requirements of the application, subject to calibration for balancing the trade-offs between false positives and false negatives.

In accordance with an embodiment, inference module 424 contextualizes the probability distribution against the backdrop of the specific application. This involves a comparative analysis, especially in instances where multiple classes have similar probability scores, to deduce the most plausible classification. In an embodiment, inference module 424 may incorporate additional decision-making rules or contextual information to guide this analysis, ensuring that the classification aligns with the practical and contextual nuances of the application.

In regression models, where the outputs are continuous values, inference module 424 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 424 incorporates domain-specific adjustments into its post-processing routine. This involves tailoring the model's output to align with specific industry knowledge or contextual information. For example, in financial forecasting, inference module 424 may adjust predictions based on current market trends, economic indicators, or recent significant events, ensuring that the outputs are both statistically accurate and practically relevant.

In an embodiment, inference module 424 includes logic to handle uncertainty and ambiguity in the model's predictions. In cases where inference module 424 outputs a measure of uncertainty, such as in Bayesian inference models, inference module 424 interprets these uncertainty measures by converting probabilistic distributions or confidence intervals into a format that can be easily understood and acted upon. This provides users with both a prediction and an insight into the confidence level of that prediction. In an embodiment, inference module 424 includes mechanisms for involving human oversight or integrating the instance into a feedback loop for subsequent analysis and model refinement.

In an embodiment, inference module 424 formats the final predictions for end-user consumption. Predictions are converted into visualizations, user-friendly reports, or interactive interfaces. In some systems, like recommendation engines, inference module 424 also integrates feedback mechanisms, where user responses to the predictions are used to continually refine and improve the model, creating a dynamic, self-improving system.

The Machine Learning API 430 is an interface that facilitates access to and interaction with the machine learning engine 410 by other modules and/or components of a system.

### 6. Machine Learning Operations

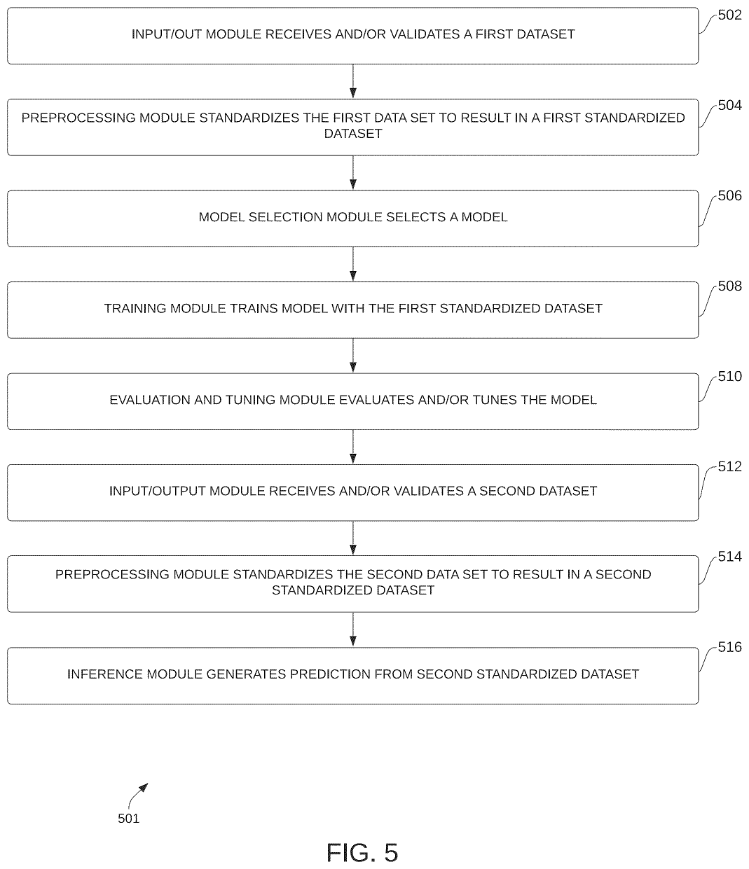

FIG. 5 illustrates a set of machine learning operations 500. In embodiments, one or more operations of the set of operations 500 is performed by a machine learning engine such as machine learning engine 410. In an embodiment, input/output module 412 receives a dataset intended for training (Operation 502). This data can originate from diverse sources, like databases or real-time data streams, and in varied formats, such as CSV, JSON, or XML. Input/output module 412 assesses and validates the data, ensuring its integrity by checking for consistency, data ranges, and types.

In an embodiment, training data is passed to data preprocessing module 414. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 414 is then fed into model selection module 416 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 418 trains the selected model with the prepared dataset (Operation 508). It implements learning algorithms to adjust the model's internal parameters, optimizing them to identify patterns and relationships in the training data. Training module 418 also addresses the challenge of overfitting by implementing techniques, like regularization and early stopping, ensuring the model's generalizability.

In an embodiment, evaluation and tuning module 422 evaluates the trained model's performance using the validation dataset (Operation 510). Evaluation and tuning module 422 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 412 receives a dataset intended for inference. Input/output module 412 assesses and validates the data (Operation 512).

In an embodiment, data preprocessing module 414 receives the validated dataset intended for inference (Operation 514). Data preprocessing module 414 ensures that the data format used in training is replicated for the new inference data, maintaining consistency and accuracy for the model's predictions.

In an embodiment, inference module 424 processes the new data set intended for inference, using the trained and tuned model (Operation 516). It applies the model to this data, generating raw probabilistic outputs for predictions. Inference module 424 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 430 allows for applications to leverage machine learning engine 410. In an embodiment, machine learning engine API 430 may be built on a RESTful architecture and offer stateless interactions over standard HTTP/HTTPS protocols. Machine learning engine API 430 may feature a variety of endpoints, each tailored to a specific function within machine learning engine 410. In an embodiment, endpoints such as “/submitData” facilitate the submission of new data for processing, while endpoints such as “/retrieveResults fetch the outcomes of data analysis or model predictions. Message level encryption (MLE) API also includes endpoints, such as “/updateModel” for model modifications and “/trainModel” to initiate training with new datasets.

In an embodiment, machine learning engine API 430 is equipped to support SOAP-based interactions. This extension involves defining a Web Services Description Language (WSDL) document that outlines the API's operations and the structure of request and response messages. In an embodiment, machine learning engine API 430 supports various data formats and communication styles. In an embodiment, machine learning engine API 430 endpoints may handle requests in JSON format or any other suitable format. For example, machine learning engine API 430 may process XML, and it may also be engineered to handle more compact and efficient data formats, such as Protocol Buffers or Avro, for use in bandwidth-limited scenarios.

In an embodiment, machine learning engine API 430 is designed to integrate WebSocket technology for applications necessitating real-time data processing and immediate feedback. This integration enables a continuous, bi-directional communication channel for a dynamic and interactive data exchange between the application and machine learning engine 410.

### 7. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks, such as unsupervised learning, semi-supervised learning, and domain adaptation.

Large language models are designed to understand, generate, and interpret human language by processing extensive collections of data. The foundational architecture behind LLMs is the transformer network, a type of neural network that excels in handling sequential data such as text. Unlike certain architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers including a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to other elements is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of LLMs may include steps, such as normalization, where the text is converted to a uniform case and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 416, when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as GPUs (Graphics Processing Units) or TPUs (Tensor Processing Units), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 422 assesses the performance of LLMs using metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 424, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for numerous applications, such as image captioning, text-to-image generation, image-to-text generation, visual question answering, and more, where understanding the relationship between different data types is crucial. By leveraging diverse datasets during training, LMMs learn to create coherent and contextually relevant outputs across various modalities, enhancing their utility in complex, real-world scenarios.

The architecture of LLMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of LMMs. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks, such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware, like GPUs or TPUs, to manage the large volumes of data and the complexity of the model calculations. Techniques, such as dropout and layer normalization, are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of LMMs are conducted using various metrics tailored to the specific tasks they are designed to perform. For example, Bilingual Evaluation Understudy scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and LMMs belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are designed for generating new data points by learning a distribution of some input data, by encoding inputs into a latent space, and/or by generating outputs by sampling from a latent space. An example VAE is therefore inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a taxonomic negative sampling-based machine learning system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied or outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data that causes data to be moved into a data cloud.

In one or more embodiments, the exposed actions may receive, as input, a request to increase or decrease existing alert thresholds. The input might identify existing in-application alert thresholds and whether to increase, decrease, or delete the threshold. Additionally, or alternatively, the input might request the microservice application to create new in-application alert thresholds. The in-application alerts may trigger alerts to the user while logged into the application or may trigger alerts to the user using default or user-selected alert mechanisms available within the microservice application itself rather than through other applications plugged into the microservices manager.

In one or more embodiments, the microservice application may generate and provide an output based on input that identifies, locates, or provides historical data and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

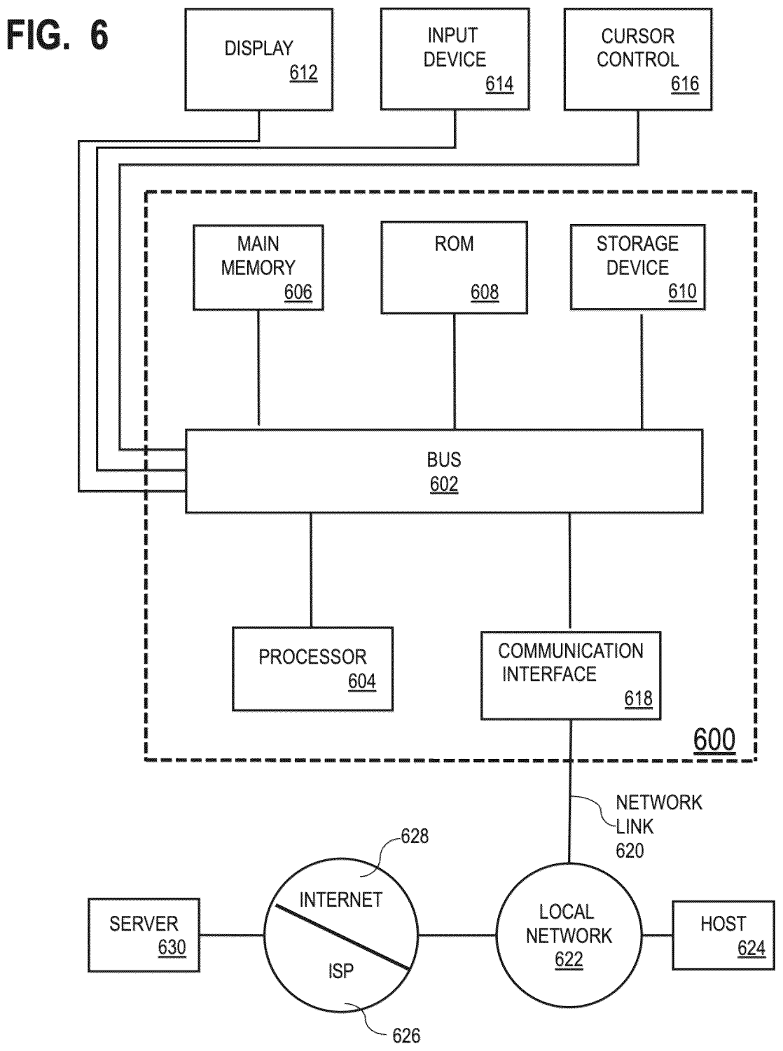

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
accessing a description of a use case;
identifying, by a first artificial intelligence (AI) agent, based on the description, a workflow associated with the use case;
identifying, by a second AI agent, a third agent configured for a task in the workflow;
generating, by the second AI agent, a prompt for the third agent; and
packaging the third agent in a callable package configured to execute the workflow; wherein
the method is performed on at least one hardware device comprising a processor.

2. The method of claim 1, wherein:
identifying the third agent comprises:
constructing a workflow task graph that defines the workflow by:
mapping a workflow task to a workflow task node of the workflow task graph;
mapping the workflow task to the task; and
mapping the task to the third agent based.

3. The method of claim 2, wherein:
The workflow task graph comprises a directed graph of a plurality of nodes and a plurality of edges, the plurality of nodes representing one or more computation steps;
the plurality of nodes comprises the node, a subsequent node, and a conditional edge mapping one or more outputs of the node to the subsequent node.

4. The method of claim 2, further comprising:
accessing feedback based a result of executing the callable package;
updating the callable package based on the feedback by:
changing a mapping of the workflow task node to a different agent task node.

5. The method of claim 2, wherein:
the workflow task graph is a directed graph comprising one or more loops from an orchestrator agent to one or more data plane agents.

6. The method of claim 1, further comprising:
accessing feedback based a result of executing the callable package;
updating the callable package based on the feedback by:
changing an assignment for the task from the third agent to a fourth agent.

7. The method of claim 1, wherein:
the callable package comprises an orchestrator agent and one or more data plane agents; and
the one or more data plane agents comprise at least one of: a task agent, a vertical agent, and a specialized agent.

8. The method of claim 1, wherein:
the third agent is a first task agent; and
the prompt comprises a description of the task, a description of a second task agent, a description of a relation between the first task agent and the second task agent, and a use condition for the second task agent.

9. The method of claim 1, further comprising:
identifying, by the first AI agent, (a) a plurality of tasks used in the workflow and (b) a plurality of data plane agents, the plurality of data plane agents including a compiler agent, an orchestrator agent, and at least one of a computation agent, a vertical agent, and a specialized agent.

10. The method of claim 1, wherein:
the prompt is a first prompt;
the first AI agent is a control plane agent;
the second AI agent is a control plane agent;
the third agent is a first data plane agent; and
the method further comprises:
generating, by the second AI agent, a second prompt for a second data plane agent, the second prompt including instructions for the second data plane agent to transmit an auxiliary prompt to a third data plane agent.

11. The method of claim 1, wherein:
the task comprises a first task of a plurality of tasks of a workflow;
the method further comprising:
identifying, by the first AI agent, a plurality of task agents configured for the plurality of tasks;
generating, by the second AI agent, a plurality of prompts for the plurality of task agents; and
packaging the plurality of task agents in a callable package configured to execute the workflow.

12. The method of claim 1, wherein:
the workflow is a first workflow of a plurality of workflows associated with the use case;
the task is a first task of a first plurality of tasks included in the first workflow; and
the callable package is a first callable package configured to execute the first workflow;
the method further comprising:
identifying the first plurality of tasks from the description of the use case;
identifying a second plurality of tasks included in a second workflow of the plurality of workflows from the description of the use case;
identifying a first plurality of task agents configured for the first plurality of tasks;
identifying a second plurality of task agents configured for the second plurality of tasks;
packaging the first plurality of task agents in the first callable package; and
packaging the second plurality of task agents in a second callable package configured to execute the second workflow.

13. The method of claim 1, wherein:
the first AI agent comprises a large language model;
the method comprising:
identifying, based on the description, a plurality of workflows and a plurality of tasks associated with the use case by inputting the description into the large language model to generate the plurality of tasks and the plurality of workflows; and
generating a plurality of directed graphs, respectively, for the plurality of workflows, wherein a directed graph comprises a hierarchy of tasks associated with completing a workflow.

14. The method of claim 1, wherein:
the first AI agent is previously trained and fine-tuned to graph task requirements of use cases based on input metadata;
the second AI agent is previously trained and fine-tuned to assign tasks to data plane agents based on a task type.

15. The method of claim 1, wherein:
the first AI agent executes an operation in a control plane;
the second AI agent executes an operation in the control plane; and
the third agent executes an operation in a data plane.

16. The method of claim 1, further comprising:
compiling, by a compiler agent in a data plane, the callable package, wherein compiling the callable package causes the callable package to be triggerable with an external API; and
executing the callable package responsive to receiving a trigger for the external API.

17. The method of claim 1, wherein:
the first AI agent comprises a first large language model (LLM); and
the second AI agent comprises a second LLM;
the method further comprising:
fine-tuning the first LLM for generating workflow definitions and task definitions from metadata descriptions of use cases;
fine-tuning the second LLM for generating task assignment prompts; or
fine-tuning the third agent for generating output.

18. The method of claim 1, wherein:
the callable package is a first callable package;
the method further comprising:
providing an output of the callable package to a human-in-the-loop module configured for:
accessing human feedback for the output; and
transmitting the human feedback to the first AI agent or the second AI agent; and
generating, based on the human feedback, a second callable package including a data plane agent different from the third agent.

19. One or more non-transitory computer readable media comprising instructions which, when executed by one or more hardware processors, cause performance of operations comprising:
accessing a description of a use case;
identifying, by a first artificial intelligence (AI) agent, based on the description, a workflow associated with the use case;
identifying, by a second AI agent, a third agent configured for a task in the workflow;
generating, by the second AI agent, a prompt for the third agent; and
packaging the third agent in a callable package configured to execute the workflow.

20. A system comprising:
at least one device including a hardware processor;
the system being configured to perform operations comprising:
accessing a description of a use case;
identifying, by a first artificial intelligence (AI) agent, based on the description, a workflow associated with the use case;
identifying, by a second AI agent, a third agent configured for a task in the workflow;
generating, by the second AI agent, a prompt for the third agent; and
packaging the third agent in a callable package configured to execute the workflow.
